(19) United States
(12) Patent Application Publication
(10) Pub. No.: US 2021/0111976 A1
(43) Pub. Date: Apr. 15, 2021

(54) METHODS AND APPARATUS FOR AUGMENTED REALITY VIEWER CONFIGURATION

(71) Applicant: QUALCOMM Incorporated, San Diego, CA (US)

(72) Inventors: David ARELLANES, San Diego, CA (US); Ramesh CHANDRASEKHAR, Oceanside, CA (US); Aditya DEGWEKAR, San Diego, CA (US); Ashwani Kumar JHA, San Diego, CA (US); Rohit BANDI, San Diego, CA (US); Walker CURTIS, San Diego, CA (US); Abhijeet BISAIN, San Diego, CA (US); Martin RENSCHLER, San Diego, CA (US)

(21) Appl. No.: 17/069,838

(22) Filed: Oct. 13, 2020

Related U.S. Application Data
(60) Provisional application No. 62/915,600, filed on Oct. 15, 2019.

(51) Int. Cl. H04L 12/26; G06T 1/20; G06F 3/14; H04L 29/06; G06F 16/13

(52) U.S. Cl. CPC H04L 43/08; G06T 1/20; G06F 3/14; G06F 8/65; G06F 16/13; G06T 2200/16; H04L 67/42

(57) ABSTRACT

The present disclosure relates to methods and apparatus for display or graphics processing. Aspects of the present disclosure can determine a communication compatibility of one or more client devices. Further, aspects of the present disclosure can modify a user space or a kernel based on the communication compatibility of each of the one or more client devices. Additionally, aspects of the present disclosure can communicate at least some data with the one or more client devices based on the modified user space or the modified kernel. Aspects of the present disclosure can also modify the kernel based on the communication compatibility of each of the one or more client devices. Aspects of the present disclosure can also extend the kernel based on the communication compatibility.

### CROSS REFERENCE TO RELATED APPLICATIONS

This application claims the benefit of U.S. Provisional Application Ser. No. 62/915,600, entitled “METHODS AND APPARATUS FOR AUGMENTED REALITY VIEWER CONFIGURATION” and filed on Oct. 15, 2019, which is expressly incorporated by reference herein in its entirety.

### TECHNICAL FIELD

The present disclosure relates generally to processing systems and, more particularly, to one or more techniques for display or graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a host device, a server, a client device, a headset or head mounted display (HMD), a display processing unit, a display processor, a central processing unit (CPU), a graphics processing unit (GPU), or any apparatus that can perform display or graphics processing. The apparatus may transmit, to each of the one or more client devices, a request for the communication compatibility of each of one or more client devices. The apparatus may also receive, from each of the one or more client devices, an indication of the communication compatibility of each of one or more client devices, where the communication compatibility of each of one or more client devices is determined based on the received indication. The apparatus may also determine a communication compatibility of each of one or more client devices. Additionally, the apparatus may identify at least one of a vender identifier (VID) or a product identifier (PID) of each of the one or more client devices, where at least one of the user space or the kernel may be modified based on at least one of the VID or the PID of each of the one or more client devices. The apparatus may also modify at least one of a user space or a kernel based on the communication compatibility of each of the one or more client devices. The apparatus may also transmit, to each of the one or more client devices, an indication for activating at least one sensor at each of the one or more client devices. Further, the apparatus may receive, from each of the one or more client devices, a data stream based on the activated at least one sensor; and display the communicated data based on the received data stream. The apparatus may also transmit, to each of the one or more client devices, a request for one or more storage files. The apparatus may also receive, from each of the one or more client devices, the one or more storage files based on the transmitted request. Moreover, the apparatus may communicate data with each of the one or more client devices based on at least one of the modified user space or the modified kernel.

In another aspect of the disclosure, a method, a computer-readable medium, and an apparatus are provided. The apparatus may be a host device, a server, a client device, a headset or head mounted display (HMD), a display processing unit, a display processor, a central processing unit (CPU), a graphics processing unit (GPU), or any apparatus that can perform display or graphics processing. The apparatus may receive, from a host device, a request for a communication compatibility of the client device. The apparatus may also determine a communication compatibility of the client device. The apparatus may also transmit, to the host device, an indication of the communication compatibility of the client device, at least one of a user space or a kernel being modified based on the indication. The apparatus may also receive, from the host device, an indication for activating at least one sensor at the client device. The apparatus may also activate the at least one sensor based on the received indication. The apparatus may also transmit, to the host device, a data stream based on the activated at least one sensor, where the communicated data is displayed based on the transmitted data stream. The apparatus may also receive, from the host device, a request for one or more storage files. The apparatus may also transmit, to the host device, the one or more storage files based on the received request. The apparatus may also communicate data with the host device based on at least one of the modified user space or the modified kernel.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example diagram of a configuration file in accordance with one or more techniques of this disclosure.

FIG. 4 illustrates an example diagram of a configuration file in accordance with one or more techniques of this disclosure.

FIG. 5 illustrates an example diagram of a configuration file in accordance with one or more techniques of this disclosure.

FIG. 6 illustrates an example diagram of a configuration file in accordance with one or more techniques of this disclosure.

FIG. 7 illustrates an example diagram of communication between a host device and a client device in accordance with one or more techniques of the present disclosure.

FIG. 8 illustrates an example flowchart of an example method in accordance with one or more techniques of this disclosure.

FIG. 9 illustrates an example flowchart of an example method in accordance with one or more techniques of this disclosure.

### DETAILED DESCRIPTION

Virtual reality (VR), augmented reality (AR), and/or extended reality (XR) content may include a compatibility between the host device and the client device, e.g., in order for the devices to function properly. In order for multiple client devices to utilize the same host device, their corresponding kernel compatibilities may be modified. Also, it may be difficult to modify a kernel in order to update or modify the kernel compatibility, e.g., for different client devices or headsets. As such, it may be challenging to modify the kernel compatibility for multiple devices, such that these devices can each utilize the same host device. Some aspects of the present disclosure can update or modify a user space or kernel. By doing so, the present disclosure can enable multiple devices to include the same kernel compatibility and be able to utilize the same host device. In some aspects, the present disclosure can modify a compatibility list in the user space, e.g., in order to enable compatibility at the kernel.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, asused herein, the term“graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

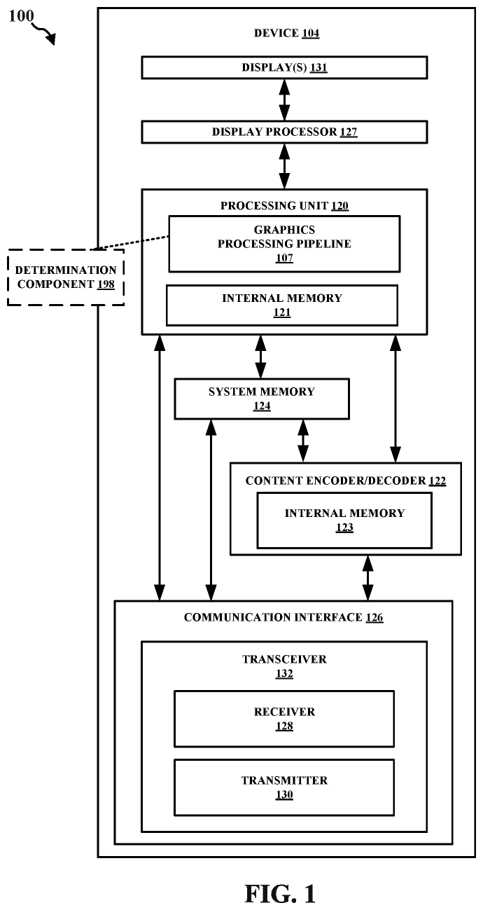

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to transmit, to each of the one or more client devices, a request for the communication compatibility of each of one or more client devices. The determination component 198 can also be configured to receive, from each of the one or more client devices, an indication of the communication compatibility of each of one or more client devices, where the communication compatibility of each of one or more client devices is determined based on the received indication. The determination component 198 can also be configured to determine a communication compatibility of each of one or more client devices. The determination component 198 can also be configured to identify at least one of a vender identifier (VID) or a product identifier (PID) of each of the one or more client devices, where atleast one of the user space or the kernel may be modified based on at least one of the VID or the PID of each of the one or more client devices. The determination component 198 can also be configured to modify at least one of a user space or a kernel based on the communication compatibility of each of the one or more client devices. The determination component 198 can also be configured to transmit, to each of the one or more client devices, an indication for activating at least one sensor at each of the one or more client devices. The determination component 198 can also be configured to receive, from each of the one or more client devices, a data streambased on the activated at least one sensor; and display the communicated data based on the received data stream. The determination component 198 can also be configured to transmit, to each of the one or more client devices, a request for one or more storage files. The determination component 198 can also be configured to receive, from each of the one or more client devices, the one or more storage files based on the transmitted request. The determination component 198 can also be configured to communicate data with each of the one or more client devices based on at least one of the modified user space or the modified kernel.

In another aspect of the disclosure, the determination component 198 can also be configured to receive, from a host device, a request for a communication compatibility of the client device. The determination component 198 can also be configured to determine a communication compatibility of the client device. The determination component 198 can also be configured to transmit, to the host device, an indication of the communication compatibility of the client device, at least one of a user space or a kernel being modified based on the indication. The determination component 198 can also be configured to receive, from the host device, an indication for activating at least one sensor at the client device. The determination component 198 can also be configured to activate the at least one sensor based on the received indication. The determination component 198 can also be configured to transmit, to the host device, a data stream based on the activated at least one sensor, where the communicated data is displayed based on the transmitted data stream. The determination component 198 can also be configured to receive, from the host device, a request for one or more storage files. The determination component 198 can also be configured to transmit, to the host device, the one or more storage files based on the received request. The determination component 198 can also be configured to communicate data with the host device based on at least one of the modified user space or the modified kernel.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may change the corresponding context. Additionally, the workload that corresponds to the mode or state may follow the changing mode or state.

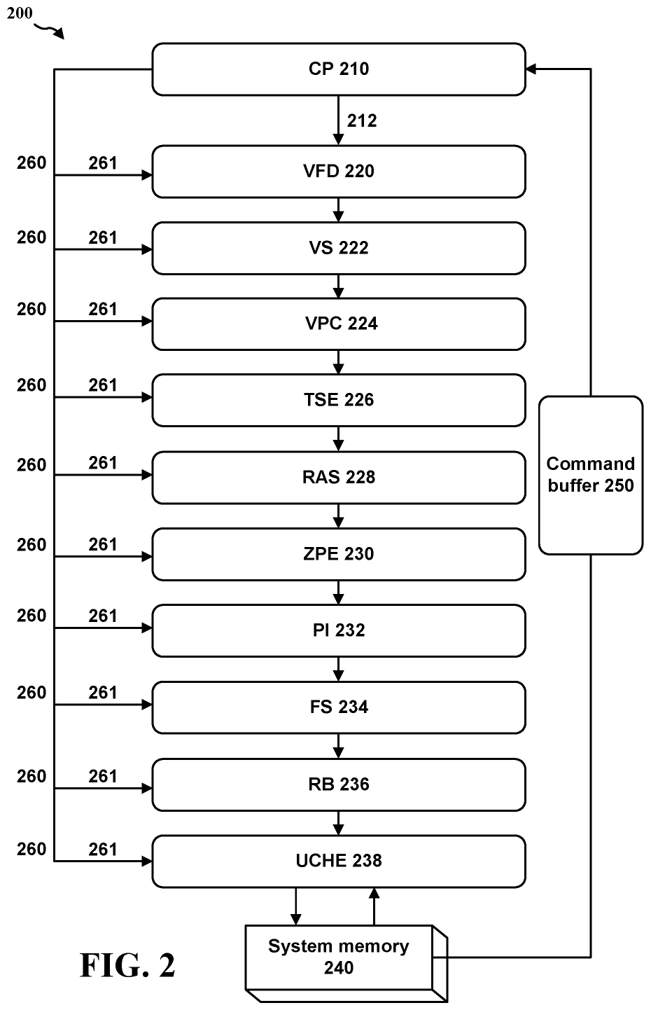

FIG. 2 illustrates an example GPU 200 in accordance with one or more techniques of this disclosure. As shown in FIG. 2, GPU 200 includes command processor (CP)210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 canthen send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

GPUs can render images in a variety of different ways. In some instances, GPUs can render an image using rendering or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. Moreover, in the binning pass, different primitives can be shaded in certain bins, e.g., using draw calls. In some aspects, during the binning pass, avisibility stream can be constructed where visible primitive s or draw calls can be identified.

In some aspects of rendering, there can be multiple processing phases or passes. For instance, the rendering can be performed in two passes, e.g., a visibility pass and a rendering pass. During a visibility pass, a GPU can input a rendering workload, record the positions of primitives or triangles, and then determine which primitives or triangles fall into which portion of a frame. In some aspects of a visibility pass, GPUs can also identify or mark the visibility of each primitive or triangle in a visibility stream. During a rendering pass, a GPU can input the visibility stream and process one portion of a frame at a time. In some aspects, the visibility stream can be analyzed to determine which primitives are visible or not visible. As such, the primitives that are visible may be processed. By doing so, GPUs can reduce the unnecessary workload of processing or rendering primitives that are not visible.

Aspects of the present disclosure can be applied to a number of different types of content, e.g., virtual reality (VR) content, augmented reality (AR) content, and/or extended reality (XR) content. In VR content, the content displayed at the user or client device can correspond to augmented content, e.g., content rendered at a host device, server, or the client device. In AR or XR content, a portion of the content displayed at the client device can correspond to real-world content, e.g., objects in the real world, and a portion of the content can be augmented content. Also, the augmented content and real-world content can be displayed in an optical see-through or a video see-through device, such that the user can view real-world objects and augmented content simultaneously.

In some aspects, in VR mode, AR mode, or XR mode, a client or user can utilize a head mounted device (HMD) or headset in order to view VR, AR, or XR content. For example, two external cameras pointing outward can capture real-world objects. The left and right camera images can also be displayed in an internal LCD or OLED display. Additionally, a pair of display lenses can be mounted in front of the display. The user can then view the external world via the display lens, the display, and/or the external camera.

As mentioned herein, VR, AR, or XR content can be generated or viewed using a host device or server and a client or user device. In some aspects, a host device can be a mobile device, a smart phone, a personal computer, a laptop, and/or any other appropriate device. Additionally, a client device can be a head mounted device (HMD), a headset, and/or any other appropriate device.

As the popularity of VR, AR, and XR experiences has increased, devices utilizing VR, AR, and XR content have been pursued by an increasing amount of consumers. Accordingly, original equipment manufacturers (OEMs) have attempted to lower the cost of experiencing VR, AR, or XR content and lower the entry barrier to VR, AR, or XR for a variety of different consumers. At the same time, OEMs have attempted to increase the quality of the VR, AR, and XR experience.

A high quality VR, AR, or XR experience can be costly. For instance, a high quality VR, AR, or XR setup may utilize high quality smart phones or PCs, in addition to costly tethered headsets or HMDs. Mobile all-in-one headsets, which can combine the aspects of a host device and a client device, remain heavier than typical headsets or HMDs and are also costly given the extra components. An attractive configuration in VR, AR, or XR content can be a split configuration, e.g., a HMD tethered to a mobile device. In these configurations, the VR, AR, or XR computations can be handled by the mobile device, and the HMD can provide sensor data to the mobile device and the display to the user.

In some aspects, VR, AR, or XR content may include a compatibility between the host device and the client device, e.g., a kernel compatibility. A kernel can be a type of code or software that powers or enables processing between the host device and the client device. In some instances, the kernel can correspond to the host device and/or the client device. Also, once shipped from the OEM, the kernel or source code may not be adjusted or modified.

Additionally, a user space may be another level of software that is above the kernel. In some instances, the user space can be easy to modify. In contrast, the kernel may be difficult to modify. In order for multiple devices to utilize the same host device, their corresponding kernel compatibilities may be modified. It may be difficult to modify a kernel in order to update or modify the kernel compatibility, e.g., for different client devices or headsets. As such, it may be challenging to modify the kernel compatibility for multiple devices, such that these devices can each utilize the same host device. Therefore, it may be beneficial to update or modify a user space or kernel so that multiple devices can include the same kernel compatibility and/or be able to utilize the same host device.

Aspects of the present disclosure can update or modify a user space or kernel, such that multiple devices can include the same kernel compatibility and/or be able to utilize the same host device. In some aspects, the present disclosure can modify a compatibility list in the user space, e.g., in order to enable compatibility at the kernel. For example, aspects of the present disclosure can include an AR or XR optimized viewer configuration to modify a user space. This AR or XR optimized viewer configuration can define an interface for connecting different AR or XR viewers to compatible client devices.

Aspects of the present disclosure can also allow for an inertial measurement unit (IMU) format between a host device and a client device. This IMU format can be information that is extracted from the code or software on the host device and/or the client device. Additionally, aspects of the present disclosure can allow for flexible and widely compatible configuration of VR, AR, or XR content, which can allow for a wide compatibility of VR, AR, or XR viewer accessories. Further, aspects of the present disclosure can allow for a dynamic addition of a vender identifier (VID) or a product identifier (PID) between the host device and the client device, e.g., a universal serial bus (USB) VID or PID. As indicated herein, wide kernel compatibility can be made possible by the dynamic addition of the VID or PID for different VR, AR, or XR client devices.

In some aspects, once successful connectivity is made between the host device and the client device, the host device can utilize multiple means of obtaining device-specific information from the client device. For example, the host device can obtain device-specific information from the client device in order to properly configure the VR, AR, or XR experience.

In some instances, this information can be included in the client device storage and/or the IMU payload. The IMU format specified by the VR, AR, or XR optimized viewer specification can allow for flexibility with client devices containing more than one IMU and/or reporting more than one sample at a time. Additionally, based on the header of the IMU format, adaptation can be performed on the compatibility of the devices.

Aspects of the present disclosure can include a number of different technical advantages and benefits. For instance, the optimized viewer configurations specified herein can enable the rapid product development by OEMs developing client devices or HMDs. Aspects of the present disclosure can also allow for the dynamic addition of a USB VID or PID. Further, aspects of the present disclosure can allow for a flexible IMU data format.

In addition, aspects of the present disclosure can provide wide compatibility, e.g., backward or forward compatibility, via the dynamic VID or PID and/or IMU format. Aspects of the present disclosure can also allow for multiple means of obtaining device specific information from a client device. By doing so, aspects of the present disclosure can enable users to select a number of different client devices or headsets, which can each be compatible with the host device or mobile phone device. For example, a user can utilize a VR-specific VR viewer, and then switch to an AR viewer, so the user can easily adjust the connectivity based on the modified kernel compatibility.

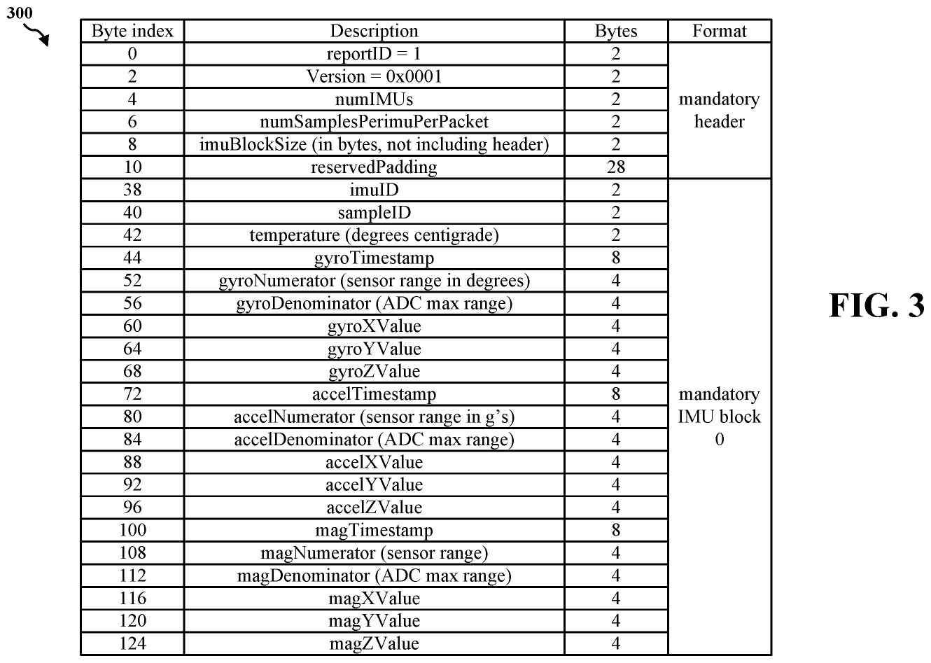

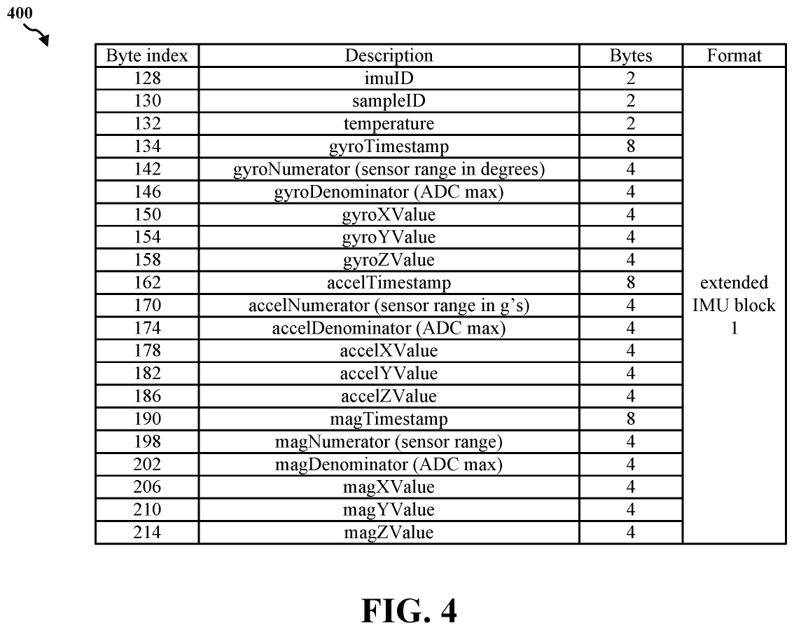

FIGS. 3 and 4 illustrate diagrams 300 and 400, respectively, of configuration files in accordance with one or more techniques of this disclosure. More specifically, FIGS. 3 and 4 each display compatibility specifications for different optimized viewers between a host device and a client device. For instance, FIGS. 3 and 4 display examples of an optimized viewer configuration file to modify the compatibility specification between a host device and a client device.

As shown in FIG. 3, diagram 300 includes a number of different fields or parameters, e.g., reportID=1, Version=OxOOO, numIMUs, numSamplesPerImuPerPacket, imuBlockSize (in bytes, not including header), reservedPadding, imuID, sampleID, temperature (degrees centigrade), gyroTimestamp, gyroNumerator (sensor range in degrees), gyroDenominator (ADC max range), gyroXValue, gyroYValue, gyroZValue, accelTinestamp, accelNumerator (sensor range in g's), accelDenominator (ADC max range), accelXValue, accelYValue, accelZValue, magTimestamp, magNumerator (sensor range), magDenominator (ADC max range), magXValue, magYValue, and magZValue.

As shown in FIG. 3, each of the fields in diagram 300 corresponds to a byte index. Further, each of the fields includes a number of bytes. Diagram 300 also includes a mandatory header and a mandatory IMU block, each of which correspond to a number of the fields. The mandatory header can correspond to an entire block in the configuration file. Also, the mandatory IMU block 0 can describe the IMU format and the necessary component to interpret that data.

As shown in FIG. 4, diagram 400 also includes a number of different fields or parameters, e.g., imuID, sampleID, temperature, gyroTimestamp, gyroNumerator (sensor range in degrees), gyroDenominator (ADC max range), gyroXValue, gyroYValue, gyroZValue, accelTimestamp, accelNumerator (sensor range in g's), accelDenominator (ADC max), accelXValue, accelYValue, accelZValue, magTimestamp, magNumerator (sensor range), magDenominator (ADC max range), magXValue, magYValue, and magZValue.

Similar to diagram 300, each of the fields in diagram 400 corresponds to a byte index. Further, each of the fields in diagram 400 includes a number of bytes. As shown in FIG. 4, if more data is desired, then new blocks can be added to the configuration file, e.g., an extended IMU block 1. As further shown in FIGS. 3 and 4, the present disclosure can perform a number of different calculations between block values. For example, aspects of the present disclosure can multiply the gyro value, e.g., gyroXvalue, gyroYvalue, or gyroZvalue, by the gyroNumerator or gyroDenominator.

As shown in FIGS. 3 and 4, alternative to some recommended units, the IMU format specified herein may allow for reporting of the raw IMU values read from the IMU's ADCs. This may be useful if the conversion to recommended units is an expensive or inaccurate computation for some XR Viewer MCUs. The numerators and denominators can then be used by the host mobile device to compute the actual value of the IMU component. For example, for an Accel XYZ reading (maximum 32 bits), the numerator (range) may be configured full scale range in gravity units “g”, where it may be assumed that the gravity constant “g” is 9.8 m/s² for the IMU. The denominator (ADC quantization) may include a maximum ADC value. For a gyro XYZ reading (maximum 32 bits), the numerator may be configured full scale range in units “degrees per second”. The denominator may include a maximum ADC value. For a Mag XYZ reading (maximum 32 bits) the numerator may be configured full scale range in units “microTeslas”. The denominator may include a maximum ADC value. Also, the temperature (maximum 16 bits) may be a most recent internal sensor temperature recorded by the IMU in units of centigrade. In some instances, a numerator or denominator value may not be utilized.

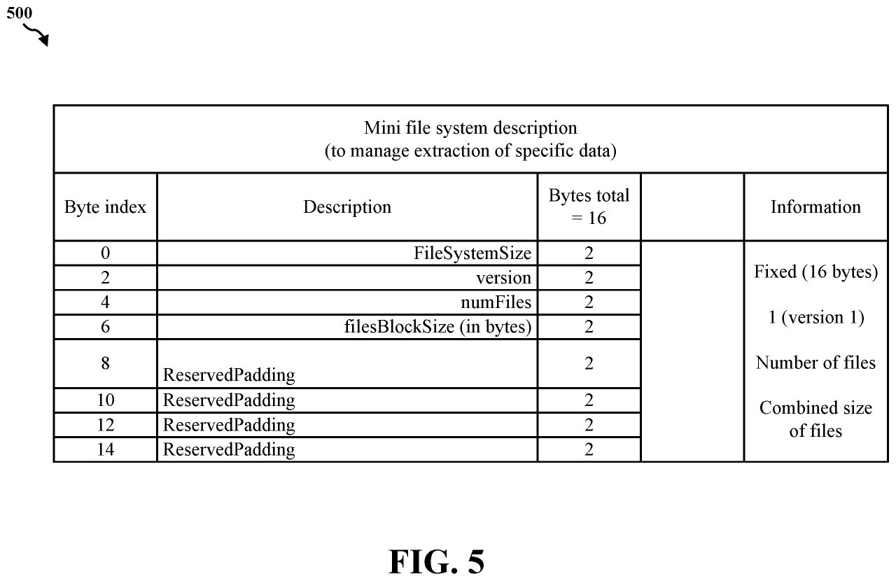

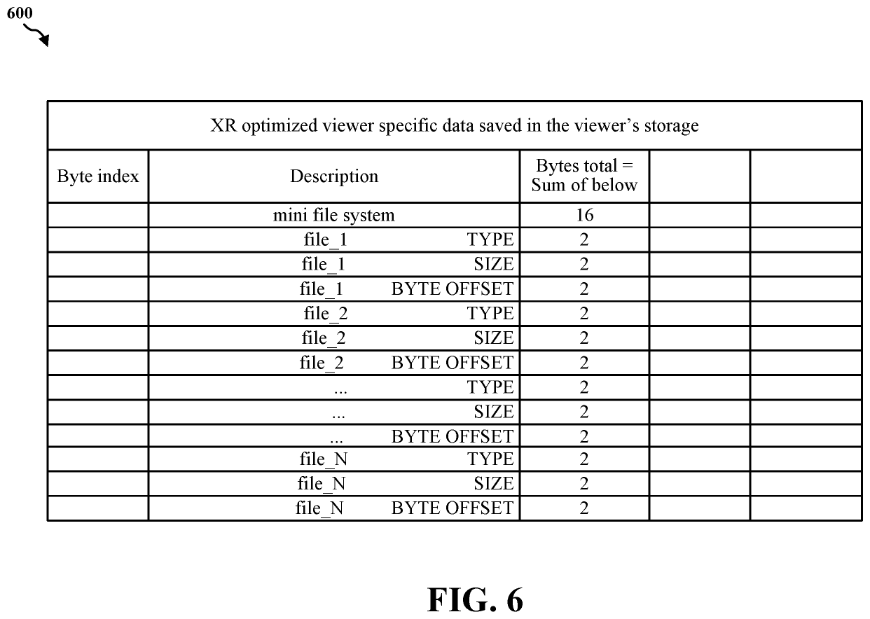

FIGS. 5 and 6 illustrate diagrams 500 and 600, respectively, of configuration files in accordance with one or more techniques of this disclosure. More specifically, FIGS. 5 and 6 each display compatibility specifications for different file systems. For instance, FIG. 5 displays a miniature file system description, which can be used to manage extraction of specific data. Also, FIG. 6 depicts a binary file, which can include XR optimized viewer specific data saved in the viewer's storage.

As shown in FIG. 5, diagram 500 is a calibration miniature file system. These file systems may include a description of a configuration of a viewer or user device, as well as how the host device can recognize and read the configuration. As shown in FIG. 6, diagram 600 is a binary file. FIGS. 5 and 6 depict that information can be exchanged that is associated with the user device or viewer. For instance, calibration information for the user device or viewer can be exchanged with the host device in order to allow the host device to identify or recognize the specific viewer, instead of the VR or AR experience.

In some aspects, the fields in the tables in FIGS. 5 and 6 can help the host device to identify the viewer or client device. For example, the serial number location in FIG. 6 can be utilized to help identify the viewer. Also, the device calibration can help the host device to identify the viewer or user device. As shown in FIG. 5, diagram 500 includes metadata for identifying the viewer or user device. As depicted in FIG. 6, diagram 600 includes the actual information that can be utilized by the host device to identify a user or viewer.

As shown in FIG. 5, diagram 500 includes a number of different fields or parameters, e.g., FileSystemSize, version, numFiles, filesBlockSize (in bytes), and ReservedPadding. The information in these fields corresponds to a number of files and a combined size of the files. Moreover, each of the fields in diagram 500 corresponds to a byte index. Also, each of the fields includes a number of bytes, e.g., 2 bytes, such that the total number of bytes is 16.

As shown in FIG. 6, diagram 600 includes a number of different fields or parameters, e.g., mini file system, file TYPE, file SIZE, and file BYTE OFFSET. For instance, diagram 600 includes a TYPE, SIZE, and BYTE OFFSET for each identified file, e.g., file_1, file_2, . . . , file_N, when N files are included. More specifically, FIG. 6 shows an example layout for a specified set of files, where each file may be identified by TYPE, SIZE, and BYTE OFFSET. The naming of the file may be handled on the host side, which may be based on the TYPE value. In some instances, given two bytes allocated for the TYPE, the maximum number of files supported may be a certain number, e.g., 65,536. Additionally, each of the fields in diagram 600 corresponds to a byte index. Further, each of the fields includes a number of bytes, where the total number of bytes may be equal to the sum of the bytes for each field.

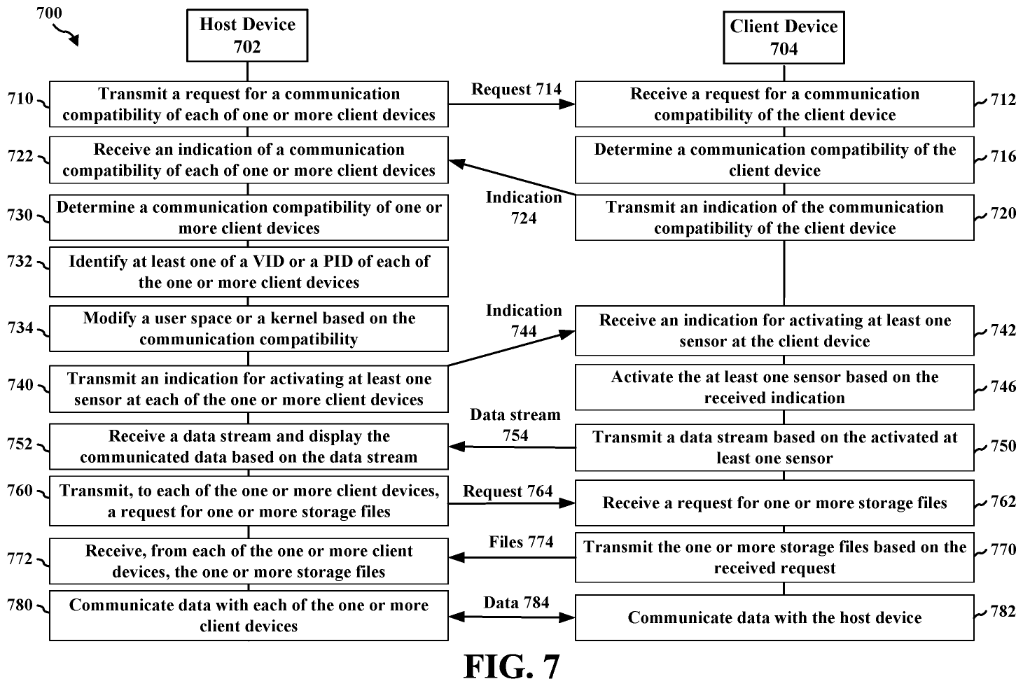

FIG. 7 is a diagram 700 illustrating example communication between a host device 702 and at least one client device 704.

At 710, host device 702 may transmit, to each of the one or more client devices, a request, e.g., request 714, for the communication compatibility of each of one or more client devices. At 712, client device 704 may receive, from a host device, a request, e.g., request 714, for a communication compatibility of the client device. At 716, client device 704 may determine a communication compatibility of the client device.

At 720, client device 704 may transmit, to the host device, an indication of the communication compatibility of the client device, e.g., indication 724, at least one of a user space or a kernel being modified based on the indication. At 722, host device 702 may receive, from each of the one or more client devices, an indication of the communication compatibility of each of one or more client devices, e.g., indication 724, where the communication compatibility of each of one or more client devices is determined based on the received indication.

At 730, host device 702 may determine a communication compatibility of each of one or more client devices. At 732, host device 702 may identify at least one of a vender identifier (VID) or a product identifier (PID) of each of the one or more client devices, where at least one of the user space or the kernel may be modified based on at least one of the VID or the PID of each of the one or more client devices. At 734, host device 702 may modify at least one of a user space or a kernel based on the communication compatibility of each of the one or more client devices.

At 740, host device 702 may transmit, to each of the one or more client devices, an indication, e.g., indication 744, for activating at least one sensor at each of the one or more client devices. At 742, client device 704 may receive, from the host device, an indication, e.g., indication 744, for activating at least one sensor at the client device. At 746, client device 704 may activate the at least one sensor based on the received indication.

At 750, client device 704 may transmit, to the host device, a data stream based on the activated at least one sensor, e.g., data stream 754, where the communicated data is displayed based on the transmitted data stream. At 752, host device 702 may receive, from each of the one or more client devices, a data stream based on the activated at least one sensor, e.g., data stream 754. Also, host device 702 may display the communicated data based on the received data stream.

At 760, host device 702 may transmit, to each of the one or more client devices, a request for one or more storage files, e.g., request 764. At 762, client device 704 may receive, from the host device, a request for one or more storage files, e.g., request 764.

At 770, client device 704 may transmit, to the host device, the one or more storage files based on the received request, e.g., files 774. At 772, host device 702 may receive, from each of the one or more client devices, the one or more storage files based on the transmitted request, e.g., files 774.

At 780, host device 702 may communicate data, e.g., data 784, with each of the one or more client devices based on at least one of the modified user space or the modified kernel. At 782, client device 704 may communicate data, e.g., data 784, with the host device based on at least one of the modified user space or the modified kernel.

In some aspects, the user space may be modified to enable communication between the kernel and each of the one or more client devices. Also, at least one of the user space or the kernel may be dynamically modified based on the VID or the PID of each of the one or more client devices. Further, at least one of the user space or the kernel may be modified for at least one of a bind process or an unbind process of a kernel space driver.

Additionally, the kernel may be modified based on the communication compatibility of each of the one or more client devices. The kernel may be further modified based on at least one of a flexible inertial measurement unit (IMU) format, a number of IMUs, a driver update, or a software update. Also, the communication compatibility of each of the one or more client devices may correspond to a kernel compatibility. In some instances, modifying the kernel based on the communication compatibility of each of the one or more client devices may further comprise extending the kernel based on the communication compatibility of each of the one or more client devices. Moreover, the data may be at least one of display data, lens data, camera data, or inertial measurement unit (IMU) data. Also, data may be calibrated data, and at least one of the display data, the lens data, the camera data, or the IMU data may be stored in a file system or a miniature file system.

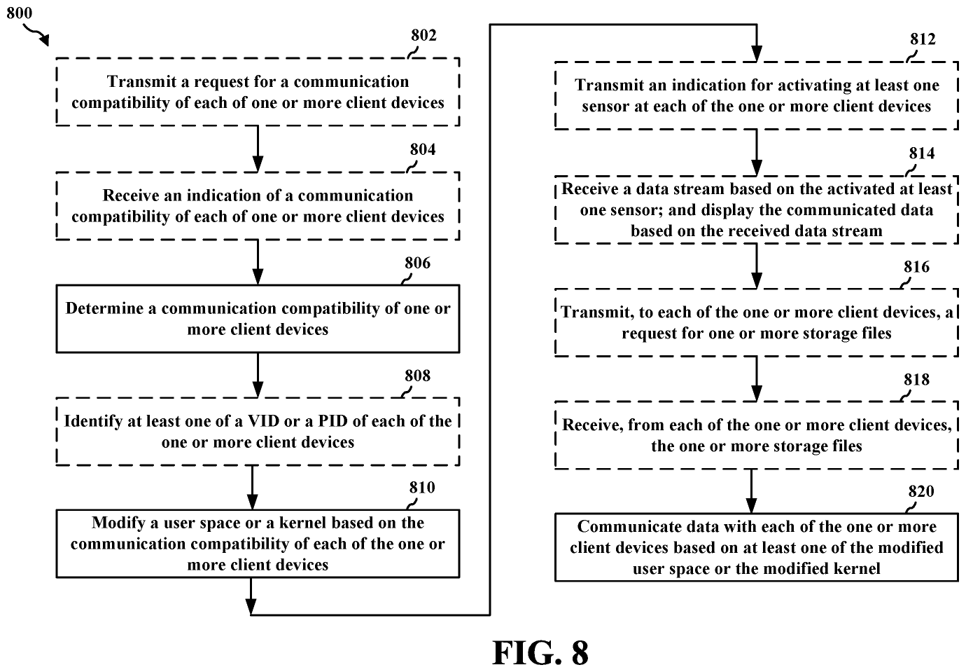

FIG. 8 illustrates an example flowchart 800 of an example method in accordance with one or more techniques of this disclosure. The method may be performed by an apparatus such as a host device, a server, a client device, a headset or HMD, a display processing unit, a display processor, a CPU, a GPU, or an apparatus for display or graphics processing.

At 802, the apparatus may transmit, to each of one or more client devices, a request for the communication compatibility of each of one or more client devices, as described in connection with the examples in FIGS. 3, 4, 5, 6, and 7.

At 804, the apparatus may receive, from each of the one or more client devices, an indication of the communication compatibility of each of one or more client devices, where the communication compatibility of each of one or more client devices is determined based on the received indication, as described in connection with the examples in FIGS. 3, 4, 5, 6, and 7.

At 806, the apparatus may determine a communication compatibility of each of one or more client devices, as described in connection with the examples in FIGS. 3, 4, 5, 6, and 7.

At 808, the apparatus may identify at least one of a vender identifier (VID) or a product identifier (PID) of each of the one or more client devices, where at least one of the user space or the kernel may be modified based on at least one of the VID or the PID of each of the one or more client devices, as described in connection with the examples in FIGS. 3, 4, 5, 6, and 7.

At 810, the apparatus may modify at least one of a user space or a kernel based on the communication compatibility of each of the one or more client devices, as described in connection with the examples in FIGS. 3, 4, 5, 6, and 7.

At 812, the apparatus may transmit, to each of the one or more client devices, an indication for activating at least one sensor at each of the one or more client devices, as described in connection with the examples in FIGS. 3, 4, 5, 6, and 7.

At 814, the apparatus may receive, from each of the one or more client devices, a data stream based on the activated at least one sensor; and display the communicated data based on the received data stream, as described in connection with the examples in FIGS. 3, 4, 5, 6, and 7.

At 816, the apparatus may transmit, to each of the one or more client devices, a request for one or more storage files, as described in connection with the examples in FIGS. 3, 4, 5, 6, and 7.

At 818, the apparatus may receive, from each of the one or more client devices, the one or more storage files based on the transmitted request, as described in connection with the examples in FIGS. 3, 4, 5, 6, and 7.

At 820, the apparatus may communicate data with each of the one or more client devices based on at least one of the modified user space or the modified kernel, as described in connection with the examples in FIGS. 3, 4, 5, 6, and 7.

In some aspects, the user space may be modified to enable communication between the kernel and each of the one or more client devices, as described in connection with the examples in FIGS. 3, 4, 5, 6, and 7. Also, at least one of the user space or the kernel may be dynamically modified based on the VID or the PID of each of the one or more client devices, as described in connection with the examples in FIGS. 3, 4, 5, 6, and 7. Further, at least one of the user space or the kernel may be modified for at least one of a bind process or an unbind process of a kernel space driver, as described in connection with the examples in FIGS. 3, 4, 5, 6, and 7.

Additionally, the kernel may be modified based on the communication compatibility of each of the one or more client devices, as described in connection with the examples in FIGS. 3, 4, 5, 6, and 7. The kernel may be further modified based on at least one of a flexible inertial measurement unit (IMU) format, a number of IMUs, a driver update, or a software update, as described in connection with the examples in FIGS. 3, 4, 5, 6, and 7. Also, the communication compatibility of each of the one or more client devices may correspond to a kernel compatibility, as described in connection with the examples in FIGS. 3, 4, 5, 6, and 7. In some instances, modifying the kernel based on the communication compatibility of each of the one or more client devices may further comprise extending the kernel based on the communication compatibility of each of the one or more client devices, as described in connection with the examples in FIGS. 3, 4, 5, 6, and 7. Moreover, the data may be at least one of display data, lens data, camera data, or inertial measurement unit (IMU) data, as described in connection with the examples in FIGS. 3, 4, 5, 6, and 7. Also, data may be calibrated data, and at least one of the display data, the lens data, the camera data, or the IMU data may be stored in a file system or a miniature file system, as described in connection with the examples in FIGS. 3, 4, 5, 6, and 7.

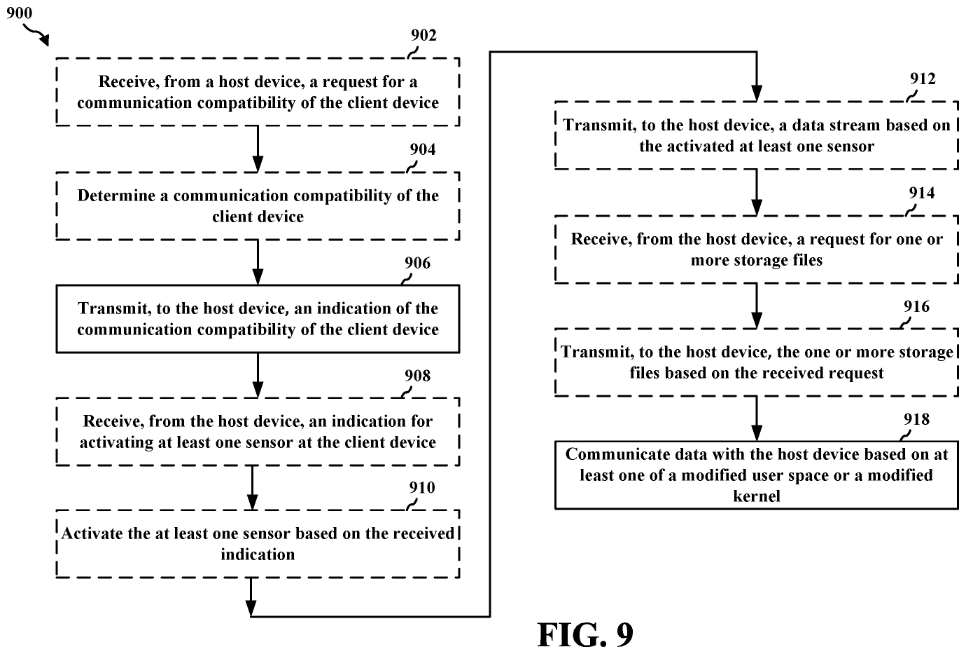

FIG. 9 illustrates an example flowchart 900 of an example method in accordance with one or more techniques of this disclosure. The method may be performed by an apparatus such as a host device, a server, a client device, a headset or HMD, a display processing unit, a display processor, a CPU, a GPU, or an apparatus for display or graphics processing.

At 902, the apparatus may receive, from a host device, a request for a communication compatibility of the client device, as described in connection with the examples in FIGS. 3, 4, 5, 6, and 7.

At 904, the apparatus may determine a communication compatibility of the client device, as described in connection with the examples in FIGS. 3, 4, 5, 6, and 7.

At 906, the apparatus may transmit, to the host device, an indication of the communication compatibility of the client device, at least one of a user space or a kernel being modified based on the indication, as described in connection with the examples in FIGS. 3, 4, 5, 6, and 7.

At 908, the apparatus may receive, from the host device, an indication for activating at least one sensor at the client device, as described in connection with the examples in FIGS. 3, 4, 5, 6, and 7.

At 910, the apparatus may activate the at least one sensor based on the received indication, as described in connection with the examples in FIGS. 3, 4, 5, 6, and 7.

At 912, the apparatus may transmit, to the host device, a data stream based on the activated at least one sensor, where the communicated data is displayed based on the transmitted data stream, as described in connection with the examples in FIGS. 3, 4, 5, 6, and 7.

At 914, the apparatus may receive, from the host device, a request for one or more storage files, as described in connection with the examples in FIGS. 3, 4, 5, 6, and 7.

At 916, the apparatus may transmit, to the host device, the one or more storage files based on the received request, as described in connection with the examples in FIGS. 3, 4, 5, 6, and 7.

At 918, the apparatus may communicate data with the host device based on at least one of the modified user space or the modified kernel, as described in connection with the examples in FIGS. 3, 4, 5, 6, and 7.

In some aspects, the user space may be modified to enable communication between the kernel and the client device, as described in connection with the examples in FIGS. 3, 4, 5, 6, and 7. Also, at least one of the user space or the kernel may be modified based on at least one of a vender identifier (VID) or a product identifier (PID) of the client device, as described in connection with the examples in FIGS. 3, 4, 5, 6, and 7. At least one of the user space or the kernel may be dynamically modified based on the VID or the PID of the client device, where at least one of the user space or the kernel may be modified for at least one of a bind process or an unbind process of a kernel space driver, as described in connection with the examples in FIGS. 3, 4, 5, 6, and 7.

Additionally, the kernel may be modified based on at least one of the communication compatibility of the client device, a flexible inertial measurement unit (IMU) format, a number of IMUs, a driver update, or a software update, as described in connection with the examples in FIGS. 3, 4, 5, 6, and 7. The communication compatibility of the client device may correspond to a kernel compatibility, where the kernel may be extended based on the communication compatibility of the client device, as described in connection with the examples in FIGS. 3, 4, 5, 6, and 7. Moreover, the data may be at least one of display data, lens data, camera data, or inertial measurement unit (IMU) data, as described in connection with the examples in FIGS. 3, 4, 5, 6, and 7. In some instances, the data may be calibrated data, and at least one of the display data, the lens data, the camera data, or the IMU data may be stored in a file system or a miniature file system, as described in connection with the examples in FIGS. 3, 4, 5, 6, and 7.

In one configuration, a method or apparatus for graphics processing is provided. The apparatus may be a host device, a server, a client device, a headset or HMD, a display processing unit, a display processor, a CPU, a GPU, or some other processor that can perform display or graphics processing. In one aspect, the apparatus may be the processing unit 120 within the device 104, or may be some other hardware within device 104 or another device. The apparatus may include means for determining a communication compatibility of each of one or more client devices. The apparatus may include means for modifying at least one of a user space or a kernel based on the communication compatibility of each of the one or more client devices. The apparatus may include means for communicating data with each of the one or more client devices based on at least one of the modified user space or the modified kernel. The apparatus may include means for transmitting, to each of the one or more client devices, a request for the communication compatibility of each of one or more client devices. The apparatus may include means for receiving, from each of the one or more client devices, an indication of the communication compatibility of each of one or more client devices, where the communication compatibility of each of one or more client devices is determined based on the received indication. The apparatus may include means for transmitting, to each of the one or more client devices, an indication for activating at least one sensor at each of the one or more client devices. The apparatus may include means for receiving, from each of the one or more client devices, a data stream based on the activated at least one sensor. The apparatus may include means for displaying the communicated data based on the received data stream. The apparatus may include means for transmitting, to each of the one or more client devices, a request for one or more storage files. The apparatus may include means for receiving, from each of the one or more client devices, the one or more storage files based on the transmitted request. The apparatus may include means for identifying at least one of a vender identifier (VID) or a product identifier (PID) of each of the one or more client devices. The apparatus may include means for receiving, from a host device, a request for a communication compatibility of the client device. The apparatus may include means for determining a communication compatibility of the client device. The apparatus may include means for transmitting, to the host device, an indication of the communication compatibility of the client device, at least one of a user space or a kernel being modified based on the indication. The apparatus may include means for communicating data with the host device based on at least one of the modified user space or the modified kernel. The apparatus may include means for receiving, from the host device, an indication for activating at least one sensor at the client device. The apparatus may include means for activating the at least one sensor based on the received indication. The apparatus may include means for transmitting, to the host device, a data stream based on the activated at least one sensor, where the communicated data is displayed based on the transmitted data stream. The apparatus may include means for receiving, from the host device, a request for one or more storage files. The apparatus may include means for transmitting, to the host device, the one or more storage files based on the received request.

The subject matter described herein can be implemented to realize one or more benefits or advantages. For instance, the described graphics processing techniques can be used by a host device, a server, a client device, a headset or HMD, a display processing unit, a display processor, a CPU, a GPU, or some other processor that can perform display or graphics processing to implement the techniques described herein. This can also be accomplished at a low cost compared to other display or graphics processing techniques. Moreover, the display or graphics processing techniques herein can improve or speed up data processing or execution. Further, the display or graphics processing techniques herein can improve resource or data utilization and/or resource efficiency.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term“processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of display processing of a host device, comprising:
determining a communication compatibility of each of one or more client devices;
modifying at least one of a user space or a kernel based on the communication compatibility of each of the one or more client devices; and
communicating data with each of the one or more client devices based on at least one of the modified user space or the modified kernel.

2. The method of claim 1, further comprising:
transmitting, to each of the one or more client devices, a request for the communication compatibility of each of one or more client devices; and
receiving, from each of the one or more client devices, an indication of the communication compatibility of each of one or more client devices, wherein the communication compatibility of each of one or more client devices is determined based on the received indication.

3. The method of claim 1, further comprising:
transmitting, to each of the one or more client devices, an indication for activating at least one sensor at each of the one or more client devices.

4. The method of claim 3, further comprising:
receiving, from each of the one or more client devices, a data stream based on the activated at least one sensor; and
displaying the communicated data based on the received data stream.

5. The method of claim 1, further comprising:
transmitting, to each of the one or more client devices, a request for one or more storage files.

6. The method of claim 5, further comprising:
receiving, from each of the one or more client devices, the one or more storage files based on the transmitted request.

7. The method of claim 1, wherein the user space is modified to enable communication between the kernel and each of the one or more client devices.

8. The method of claim 1, further comprising:
identifying at least one of a vender identifier (VID) or a product identifier (PID) of each of the one or more client devices, wherein at least one of the user space or the kernel is modified based on at least one of the VID or the PID of each of the one or more client devices.

9. The method of claim 8, wherein at least one of the user space or the kernel is dynamically modified based on the VID or the PID of each of the one or more client devices.

10. The method of claim 8, wherein at least one of the user space or the kernel is modified for at least one of a bind process or an unbind process of a kernel space driver.

11. The method of claim 1, wherein the kernel is modified based on the communication compatibility of each of the one or more client devices.

12. The method of claim 11, wherein the kernel is further modified based on at least one of a flexible inertial measurement unit (IMU) format, a number of IMUs, a driver update, or a software update.

13. The method of claim 11, wherein the communication compatibility of each of the one or more client devices corresponds to a kernel compatibility.

14. The method of claim 11, wherein modifying the kernel based on the communication compatibility of each of the one or more client devices further comprises extending the kernel based on the communication compatibility of each of the one or more client devices.

15. The method of claim 1, wherein the data is at least one of display data, lens data, camera data, or inertial measurement unit (IMU) data.

16. The method of claim 15, wherein data is calibrated data, and at least one of the display data, the lens data, the camera data, or the IMU data is stored in a file system or a miniature file system.

17. A method of display processing of a client device, comprising:
receiving, from a host device, a request for a communication compatibility of the client device;
determining a communication compatibility of the client device;
transmitting, to the host device, an indication of the communication compatibility of the client device, at least one of a user space or a kernel being modified based on the indication; and
communicating data with the host device based on at least one of the modified user space or the modified kernel.

18. The method of claim 17, further comprising:
receiving, from the host device, an indication for activating at least one sensor at the client device; and
activating the at least one sensor based on the received indication.

19. The method of claim 18, further comprising:
transmitting, to the host device, a data stream based on the activated at least one sensor, wherein the communicated data is displayed based on the transmitted data stream.

20. The method of claim 17, further comprising:
receiving, from the host device, a request for one or more storage files.

21. The method of claim 20, further comprising:
transmitting, to the host device, the one or more storage files based on the received request.

22. The method of claim 17, wherein the user space is modified to enable communication between the kernel and the client device.

23. The method of claim 17, wherein at least one of the user space or the kernel is modified based on at least one of a vender identifier (VID) or a product identifier (PID) of the client device.

24. The method of claim 23, wherein at least one of the user space or the kernel is dynamically modified based on the VID or the PID of the client device, wherein at least one of the user space or the kernel is modified for at least one of a bind process or an unbind process of a kernel space driver.

25. The method of claim 17, wherein the kernel is modified based on at least one of the communication compatibility of the client device, a flexible inertial measurement unit (IMU) format, a number of IMUs, a driver update, or a software update.

26. The method of claim 25, wherein the communication compatibility of the client device corresponds to a kernel compatibility, wherein the kernel is extended based on the communication compatibility of the client device.

27. The method of claim 17, wherein the data is at least one of display data, lens data, camera data, or inertial measurement unit (IMU) data.

28. The method of claim 27, wherein data is calibrated data, and at least one of the display data, the lens data, the camera data, or the IMU data is stored in a file system or a miniature file system.

29. An apparatus for display processing of a host device, comprising:
a memory; and
at least one processor coupled to the memory and configured to:
determine a communication compatibility of each of one or more client devices;
modify at least one of a user space or a kernel based on the communication compatibility of each of the one or more client devices; and
communicate data with each of the one or more client devices based on at least one of the modified user space or the modified kernel.

30. An apparatus for display processing of a client device, comprising:
a memory; and
at least one processor coupled to the memory and configured to:
receive, from a host device, a request for a communication compatibility of the client device;
determine a communication compatibility of the client device;
transmit, to the host device, an indication of the communication compatibility of the client device, at least one of a user space or a kernel being modified based on the indication; and
communicate data with the host device based on at least one of the modified user space or the modified kernel.
